(19) United States
(12) Patent Application Publication
(10) Pub. No.: US 2015/0103052 A1
(43) Pub. Date: Apr. 16, 2015

(54) DIRECTION INPUT DEVICE AND METHOD FOR OPERATING USER INTERFACE USING SAME

(71) Applicant: GACHISOFT CO., LTD., Daejeon, Yuseong-gu (KR)

(72) Inventor: Ho-Yon Kim, Sejong-si (KR)

(73) Assignee: GACHISOFT CO., LTD., Daejeon, Yuseong-gu (KR)

(21) Appl. No.: 14/401,620

(22) PCT Filed: Apr. 23, 2013
(86) PCT No.: PCT/KR2013/003458

§ 371 Date: Nov. 17, 2014

(30) Foreign Application Priority Data
May 17, 2012 (KR) 10-2012-0052656

(51) Int. Cl. G06F 3/042

(52) U.S. Cl. CPC G06F 3/0421; G06F 2203/0338
USPC 345/175

(57) ABSTRACT

A direction input device and a method for operating a user interface using the same are disclosed. The direction input device, according to one embodiment of the present invention, comprises: a pad which includes, on one surface thereof, a marked surface having marks with different codes according to each mark, or which is integrated with the marked surface; an optical unit which is physically connected to the pad in the direction of the marked surface of the pad, irradiates the marked surface of the pad with light through a light source, senses light reflected from a predetermined mark on the marked surface through a sensor when a user force is applied, and converts the light into an image signal; and a connecting unit for connecting the pad and the optical unit.

### TECHNICAL FIELD

The following description relates to an input device, and more particularly to a direction input device.

### BACKGROUND ART

Using an input device, a user is able to manipulate an object displayed on a screen of an electronic device. For example, the user may change a location or direction of a mouse pointer displayed on the screen. Examples of the input device includes a mouse, a joystick, a trackball, a touch pad, a track pad, and the like. The mouse is the most commonly used input device. However, a surface is indispensable when using a mouse. Thus, it is difficult to use the mouse in a mobile environment. In addition, as the surface needs to be large and it is inconvenient to use the mouse on a small desk, the work space should be large enough to use the mouse freely.

In the mobile environment, a touch pad and a track pad are commonly used. The two devices are convenient to use, but an incorrect input occurs due to an unintended touch of a user or even a correct input may not be sensed due to occurrence of static electricity. For those reasons, people engaged in drawing pictures or diagrams in detail or performing sensitive tasks requiring precise control prefer using a mouse rather than touch in many cases.

Using a joystick or track ball makes it relatively easy to input a direction, but inconvenient to control a moving distance, and thus, similarly to touching, it is inappropriate for precision-oriented tasks, for example, drawing pictures or performing CAD.

Among conventional devices, a joystick uses mechanic operations and a simple sensor and thus is appropriate for detailed inputs; a mouse is inconvenient because a flat surface is essential or it is necessary to lift up and then put down the mouse in order to extend a moving distance; and a track pad is hard to control using a precise movement due to a different degree of friction between fingers.

### Technical Problem

According to an exemplary embodiment, an input device and a method for operating a user interface using the same are proposed, which, unlike a mouse, does not require a surface to input and control a direction or a distance and is not influenced by finger friction or static electricity generated by a touch.

### Technical Solution

In one general aspect, there is provided a direction input device including: a pad unit configured to comprise a marked surface formed on one side thereof and having marks of different codes or to be integrated with the marked surface; an optical unit physically connected to the pad unit in a direction toward the marked surface and configured to irradiate light through a light source onto the marked surface of the pad unit, to sense light reflected from a specific mark on the marked surface of the pad unit by using a sensor, and to convert the reflected light into an image signal; and a connecting unit configured to connect the pad unit and the optical unit.

In another general aspect, there is provided a method for operating a user interface using a direction input device, the method including: receiving, by a pad of a pad unit, generated light from a light source; in response to a user's force being applied, moving, by a marked surface of the pad unit and an optical unit, in a relative direction to reflect received from the light source on a specific mark on the marked surface; sensing, by a sensor of the optical unit, the light reflected from the specific mark on the marked surface and converting the reflected light into an image signal; and calculating input parameters including a user input direction and distance information by analyzing the image signal that is converted by the sensor.

### Advantageous Effects

According to an exemplary embodiment, the present disclosure is portable and convenient to use. That is, it does not need a surface for support, unlike a mouse, and a configuration of an integrated pad unit with an optical unit as one body allows mobile use in a three-dimensional (3D) space.

In addition, the present disclosure enables precise inputs. That is, unlike a touch pad, the present disclosure is able to precisely respond according to a magnitude of an input signal, without being influenced by finger friction or static electricity generated by a touch.

Further, an input device and a space may be more compact. Even though a mouse has become smaller, because the mouse requires sufficient space in which to move freely, an area larger than the size of the specific structure of the mouse is necessary; however, if the present disclosure is used, it is possible to manufacture a compact direction input device.

### DESCRIPTION OF DRAWINGS

FIG. 1 is a diagram illustrating a configuration of a direction input device according to an exemplary embodiment of the present disclosure;

FIG. 2 is a diagram illustrating an outer appearance of an input device according to an exemplary embodiment of the present disclosure;

FIG. 3 is a diagram illustrating an outer appearance of an input device according to another exemplary embodiment of the present disclosure;

FIGS. 4A to 4C are diagram illustrating an outer appearance of an input device according to yet another exemplary embodiment of the present disclosure;

FIGS. 5A and 5B are diagram illustrating an outer appearance of a pad unit of an input device according to various exemplary embodiments of the present disclosure;

FIG. 6 is a diagram illustrating an inner configuration of an input device including a processor according to an exemplary embodiment of the present disclosure;

FIG. 7 is a diagram illustrating an example of a marked surface of a pad unit according to an exemplary embodiment of the present disclosure;

FIGS. 8A and 8B are diagrams illustrating an example of a valid mark and an example of an invalid mark on a marked surface.

FIG. 9 is a diagram illustrating a marked surface that is designed to make it easy to read marks according to an exemplary embodiment of the present disclosure;

FIG. 10 is a diagram illustrating an interval between marks on a marked surface according to an exemplary embodiment of the present disclosure; and

FIG. 11 is a flowchart illustrating a method for operating a user interface using an input device according to an exemplary embodiment of the present disclosure.

### MODE FOR INVENTION

The invention is described more fully hereinafter with reference to the accompanying drawings, in which exemplary embodiments of the invention are shown. In the following description, well-known functions or constructions are not described in detail since they would obscure the invention in unnecessary detail. The terms used herein are defined in consideration of the functions of elements in the present invention. The terms can be changed according to the intentions or the customs of a user and an operator. Therefore, definitions of the terms should be made on the basis of the overall context.

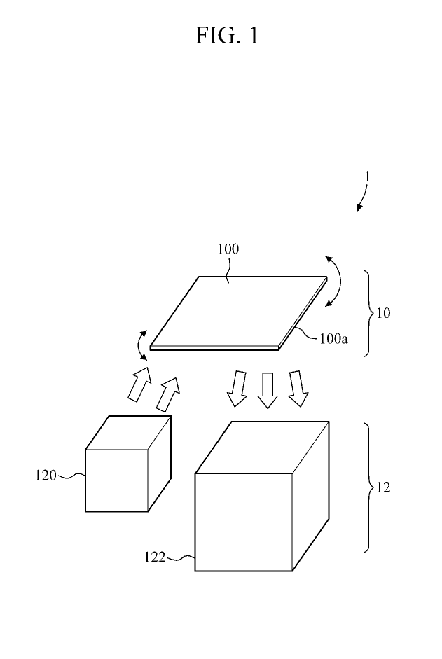

FIG. 1 is a diagram illustrating a configuration of a direction input device (hereinafter, referred to as an ‘input device’) 1 according to an exemplary embodiment of the present disclosure.

An input device 1 is a pointing device that enables user manipulation for an object to be displayed on a screen of an electronic device. The object to be displayed includes a mouse pointer to be displayed on the screen. The input device 1 may be in a portable form, in a form separate from the electronic device, or in a form embedded in a portable electronic device. The electronic device may change direction or location of an object displayed on a screen by receiving a magnitude, a direction, a speed and distance information of an input, which are input parameters, from the input device (1). The electronic device includes all devices with a display function, for example, any kind of computers, Personal Digital Assistant (PDA), portable electronic device, mobile phone, cell-type smart phone, notebook computer, and the like.

Referring to FIG. 1, the input device 1 includes a pad unit 10, an optical unit 12, wherein the pad unit 10 includes a pad 100 and a marked surface 100a, and the optical unit 12 includes a light source 120 and a sensor 122.

The pad 100, the light source 120 and the sensor 122 are optically connected. Herein, the optical connection indicates an arbitrary connection that allows light to reach a specific target using only air through a light guide member/medium, a physical channel, or a combination thereof.

The light source 120 irradiates with light, and the irradiating light may include either or both a visible ray and invisible ray. One example of a visible ray is infrared ray. The light source 120 may be in a form of light emitting diode (LED). Light irradiated from the light source 120 reaches the pad 100, and some of them may be reflected. At this point, below the pad 100 moved by an input object, such as a user's fingertip or palm, the sensor 122 at a fixed location detachable from the pad 100 may receive light reflected from the marked surface 100a of the pad.

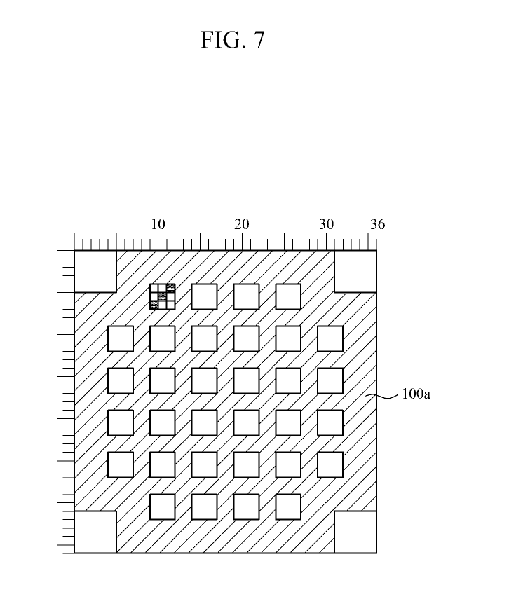

As shown in FIG. 1, at the bottom of the pad 100, the marked surface 100 has marks with different codes according to each mark. For example, a different code, such as 3×3 or 4×4, for each mark is printed on the marked surface 100a. The code may be in a form similar to a two-dimensional (2D) barcode. Since each mark has a different code, the sensor 122 is enabled to identify a location of the current mark on the marked surface 100a by reading a code of a specific mark, and thus identifying a relative location between the current marked surface and the optical unit 12 using the identified location of the current mark. A code formed on the marked surface 100a may be printed in a specific narrow area using a semiconductor etch equipment and the like. That is, a code is printed in a very narrow area which allows for precise response to a slight movement. Of course, size of a mark is associated with resolution of a camera. If the resolution is high, precise control is possible even though the size of each code may be large or the number of codes may be low. Examples of the marked surface 100a having marks of different codes are described with reference to FIGS. 7 to 10.

According to an exemplary embodiment, the optical unit 12 moving by a user's input is fixed on the marked surface 100a of the pad 100. Accordingly, the marked surface 100a moves against a moving direction of the optical unit 12 according to a force applied by a user's input from the user's fingertip or palm. According to another exemplary embodiment, the marked surface 100a may be fixed and the optical compartment 12 may be configured to move. In this case, in response to a force of a user's input, which is applied by a user's fingertip or palm, the optical unit 12 moves in a reverse direction relative to the marked surface 100a.

In response to the user's input, a specific mark among all the marks formed on the marked surface 100a reflects light received from the light source 120 to the sensor 122. Without the marked surface 100a, input controlling according to a finger touch movement may not be precise and inconsistent due to friction of a finger. In addition, in a case of a long moving distance, repeated touch by a finger is required. However, in a case of using the marked surface 100a as described in the present disclosure, the current relative location of the marked surface 100a may be identified, so it is possible to recognize an input that has moved relative to the optical unit 12 and to control the marked surface 100a to keep moving at a speed corresponding to magnitude of a vector that has moved relative to a specific direction), and thereby, repeated touch is unnecessary.

The sensor 122 senses light reflected from a marked surface 100a of the pad 100: that is, the sensor 122 senses light reflected from a specific mark on the marked surface 100a and converts the reflected light into an electric signal. The sensor 122 may be an image sensor or a camera.

According to another exemplary embodiment of the present disclosure, lenses may be further included between the light source 120 and the pad 100 and between the pad 100 and the sensor 122. A lens between the light source 120 and the pad 100 collects light generated in the light source 120, and the lens collects light reflected from the pad 100 and transfers the reflected light to the sensor 122.

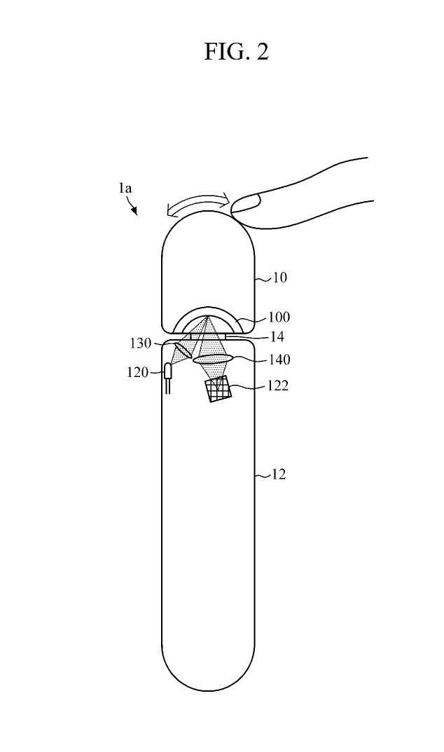

FIG. 2 is a diagram illustrating an outer appearance of an input device 1a according to an exemplary embodiment of the present disclosure.

Referring to FIG. 2, the input device 1 consists of the pad unit 10, which includes the pad 100 having a marked surface, the optical unit 12, which includes the light source 120, the sensor 122, the lenses 130 and 140, and a connecting unit 14.

The input device 1a may be made in portable form. For example, the input device 1a may be made in stick form, just like the ballpoint pen type as shown in FIG. 2. In this case, if user pressure is applied on the pad unit 10 formed at the bottom of the marked surface 100a, for example, if the pad 100 is moved horizontally and vertically with respect to the center point or if pressure is applied, an input process may start. Meanwhile, the input device 1a is in the form of a ballpoint pen, but it is merely exemplary and the input device 1a may be in various forms.

As illustrated in FIG. 2, the pad unit 10 and the optical unit 12 are physically integrated, but enabled to move horizontally and vertically relative to each other with a movement fixed in one direction. The light source 120 and the sensor 122 of the optical unit 12 may be fixed in a direction toward the marked surface 100a of the pad unit 10, while the pad 100 and the marked surface 100a of the pad unit 10 may be faced toward the optical unit 12 so as to move according to a user input. Alternatively, the pad 10 may be fixed while the optical unit 12 may be configured to move.

The connecting unit 14 connecting the pad unit 10 and the optical unit 12 may be, for example, a connection member for a joystick or a button. The connecting unit 14 may be configured to have two axes so as to enable horizontal and vertical movement, or may be configured to allow movement in a plane.

According to an exemplary embodiment, the pad unit 10 may be in the form of a button or a capsule. The pad unit 10 may move in a specific direction, such as a horizontal or a vertical direction, or rotate freely regardless a specific direction.

As shown in FIG. 2, the pad unit 10 includes a housing having an outer surface that a user may touch. In addition, the pad unit 10 includes the pad 100 inside the housing. The pad 100 includes the marked surface 100a which faces the optical unit 12, and has marks of different codes according to a mark. The marked surface 100a of the pad 100 reflects received light to the sensor 122 through a specific mark on the marked surface 100a that moves in a direction identical or opposite to that of a force applied by the user's touch.

As the marked surface 100a formed on one surface of the pad unit 10 or the optical unit 12 is configured to move, it is possible to calculate not just a relative moving direction of the marked surface 100a, but a relative location thereof. That is, by calculating direction and magnitude of movement that occurs relative to a center of the marked surface 100a in response to a user's input, it is possible to cause a vector input, such as a mouse-based vector input, to occur. Finger touch allows only measurement of a moving direction of an image by comparing the image with previous and subsequent images and movement of the finger touch is not smooth due to friction; however, using the pad unit 10 having marks printed therein allows not just to identify a moving direction, such as a direction of a joystick, but to precisely calculate relative location and distance from a starting point and make a user input more smooth.

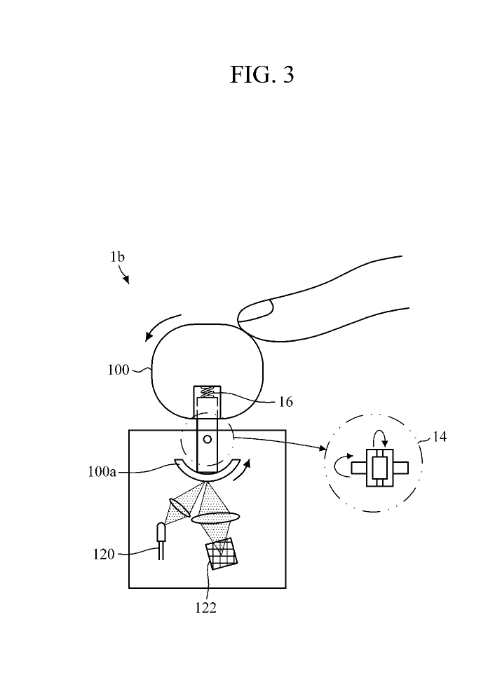

FIG. 3 is a diagram illustrating an outer appearance of an input device 1b according to another exemplary example of the present disclosure.

The difference between the input device 1b in FIG. 3 and the input device 1a in FIG. 1 lies in the fact that the marked surface 100a of the input device 1b in FIG. 3 is located, not above, but below the connecting unit 14. For example, as shown in FIG. 3, the marked surface 100a is formed below the connecting unit 14 that acts as an axis. In this case, there is nothing disrupting the sensor 122 to acquire an image and it enables the pad unit 10 to move more easily. The connecting unit 14 may be configured to have two axes so as to enable horizontal and vertical movement, or may be configured to enable movement in a plane.

According to another exemplary embodiment of the present disclosure, the input device 1b include a restoration component 16. The restoration component 16 may be formed between the pad 100 of the pad unit 16 and the connecting unit 14. In a case where no force is applied by a user, the restoration component 16 functions to restore relative locations of the pad unit 10 and the optical unit 12 to be starting points, and the restoration component 16 may be a spring and the like. The starting point may be desirably a center of a marked surface; however, it may be hard to adjust the starting point to be the very center of the marked surface due to looseness of the restoration component 16, and thus, it is possible to always reset the relative location as a starting point when a user's force is not applied.

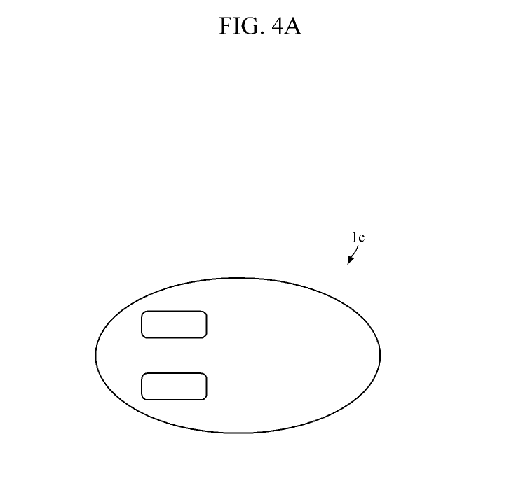

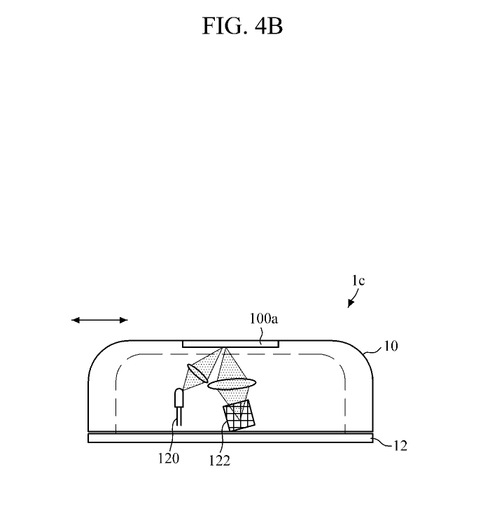

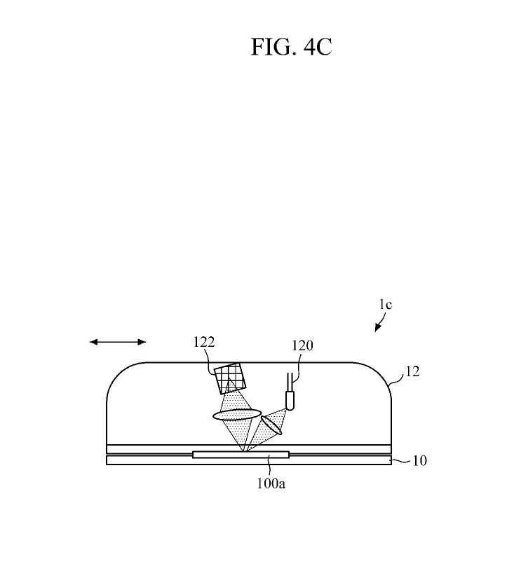

FIGS. 4A to 4C are diagrams illustrating an outer appearance of an input device 1c according to yet another exemplary embodiment of the present disclosure.

Referring to FIGS. 4A to 4C, the input device 1c may be in the form of a mouse. FIG. 4A illustrates the top surface of the input device 1c, and FIGS. 4B and 4C illustrate the side of the input device 1c according to various exemplary embodiments.

As shown in FIG. 4A, the pad unit 10 may further include a button formed on the top surface thereof. That is, similarly to a mouse, left and right buttons may be added on the top surface of the pad unit 10. In another example, the pad unit 10 itself may be designed in the form of a clickable button.

Meanwhile, as shown in FIG. 4B, the optical unit 12 may be formed and fixed below the marked surface 100a of the pad unit 10, so that the pad unit 10 may move according to a user's input. In this case, the pad unit 10 may include left and right buttons formed on the top surface thereof that a user may click, or may be in the form of a clickable button. Alternatively, as shown in FIG. 4C, the optical unit 12 may be formed and fixed above the marked surface 100a of the pad unit 10, so that the optical unit 12 may move according to a user's input.

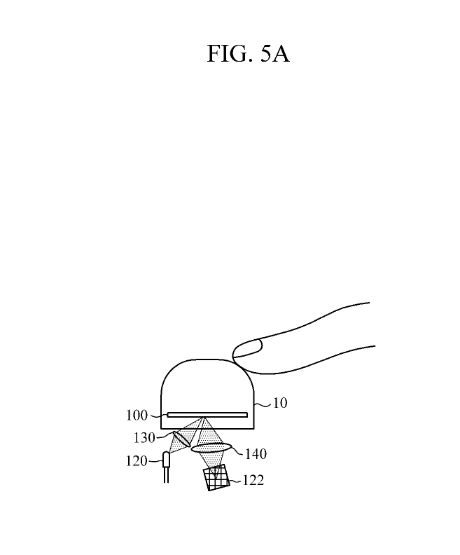

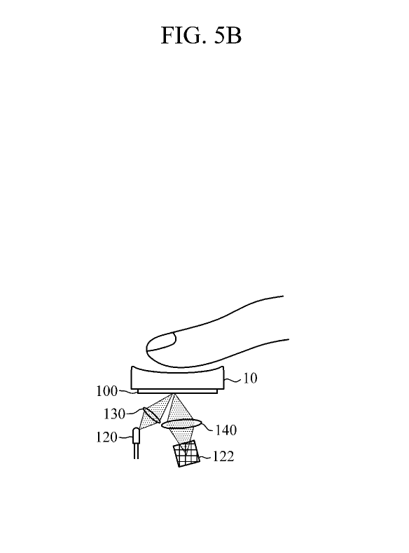

FIGS. 5A and 5B are diagrams illustrating an outer appearance of the pad unit 10 of the input device 1 according to various exemplary embodiments of the present disclosure.

According to an exemplary embodiment, the pad unit 10 may be in the form of a joystick having a convex outer surface, as shown in FIG. 5A, or may be in the form of a button having a concave outer surface, as shown in FIG. 5B. In a case of the button type, the pad unit 10 may start to receive a user's input if there is pressure, and may stop receiving the user's input if pressure on a marked surface is relieved or if the marked surface moves to a starting point. Pressure on a button may be set to function as a click button of a mouse to determine whether to receive a user's input, or may be a two-stage button that can function both as a receipt start/end signal and as a mouse button.

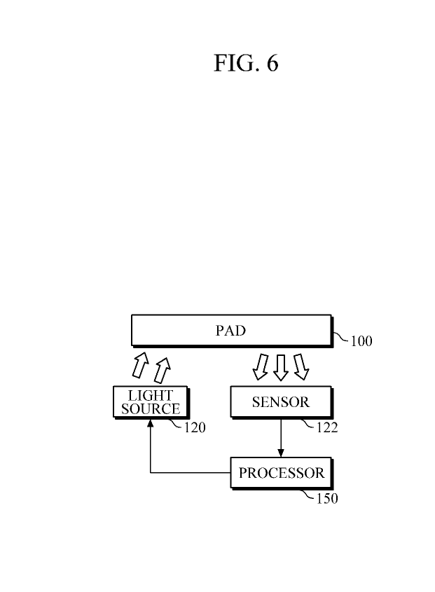

FIG. 6 is a diagram illustrating an inner configuration of the input device 1 including a processor 150 according to an exemplary embodiment of the present disclosure.

Referring to FIG. 6, the input device 1 includes a pad 100, a light source 120, a sensor 122, and a processor 150.

Configurations of the pad 100, the light source 120, and the sensor 122 are described with reference to the above-described drawings, and thus, the following descriptions are provided mainly about the processor 150.

The processor 150 controls the light source 120 to irradiate light. In addition, the processor 150 calculates the current relative location of the pad 100 by analyzing an image signal acquired from the sensor 122 and calculating a location of a mark on the marked surface of the pad 100 at a time when the light is irradiated. In addition, the processor 150 calculates a difference between a previously acquired relative location of the pad 100 and the current relative location of the pad 100, and calculates a moving speed based on time required to move from the previously acquired relative location to the current relative location. Then, the processor 150 determines input parameters, which includes a magnitude, speed, and a direction vector of an input, by using the calculated relative location and moving speed.

Using a marked surface of the pad 100 that relatively moves by a user's input, the processor 150 may calculate an input vector value: the more distant a location of a mark is from a starting point, the more quickly an input may be caused to occur constantly, wherein the input is identical to moving a mouse quickly; and the closer a location of a mark is to a starting point, the more slowly an input may be caused to occur, wherein the input is identical to slowly moving a mouse in a corresponding vector direction. That is, without an operation of constantly moving or repeatedly lifting and putting down a mouse and the like so as to extend a moving distance, the present disclosure allows constant inputs in a corresponding direction through a movement in one direction, which is the same manner as when a joystick is used.

The difference between the input device 1 of the present disclosure and a joystick lies in the fact the input device 1 is capable of precisely controlling a magnitude of a vector value or a moving speed according to a location. Although it is possible to input a magnitude using a pressure sensor or a moving distance in the case of the joystick, it is less precise than using optical characteristics, as described in the present disclosure. In addition, the input device 1 may determine an input speed or a magnitude of a direction vector according to a speed of the marked surface which has been moved from the previous image (that is, of which coordinates have been changed). That is, the input device 1 may calculate an input vector of a corresponding direction (e.g., a moving speed of a mouse) based on a speed of movement from a starting point to the current coordinates of the marked surface and on a function value for a distance of the marked surface from the starting point.

The difference of the input device 1 of the present disclosure and a touch pad lies in the fact that, unlike the touch pad, the input device 1 is able to precisely respond according to magnitude of an input signal without being influenced by static electricity generated by finger friction and touching.

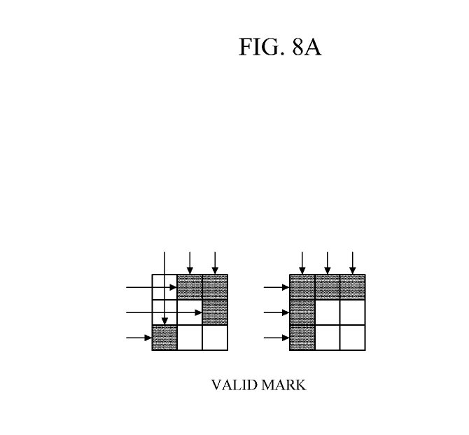

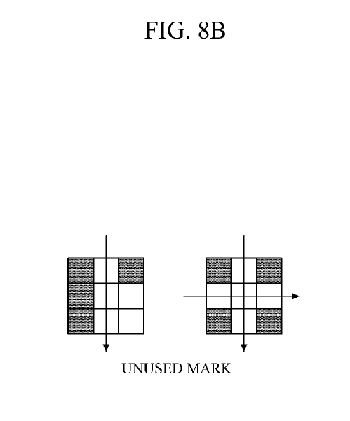

FIG. 7 is a diagram illustrating an example of a marked surface of the pad unit 10 according to an exemplary embodiment of the present disclosure, and FIGS. 8A and 8B are diagrams illustrating an example of a valid mark and an example of an invalid mark on the marked surface.

Referring to FIG. 7, according to an exemplary embodiment, the marked surface 100a may consist of marks of 3×3. As illustrated in FIG. 7, marks of different patterns are arranged on the marked surface 100a with alignment in rows and columns.

In this case, as illustrated in FIG. 8A, the mark pattern is designed not to have any empty cells in a projection onto X-axis and Y-Axis. That is, it is coded such that there are no empty rows or columns with respect to cells composing a mark on the marked surface. Herein, the emptiness indicates a binary code value of ‘0.’ By taking into consideration such a constraint in a case of a mark of 3×3, the number of codes to be generated is 32. That is, if a binary code is used, the number of codes is 29, and thus, 128 code patterns are possible; however, if one or more empty rows or columns are not counted, as illustrated in FIG. 8B, the number of code patterns is 32. That is, the mark pattern is designed, as illustrated in FIB. 8A, without any empty cell in a row or column, as illustrated in FIG. 8B.

Then, when analyzing an image signal acquired by a sensor, it is possible to easily identify a location of a valid mark simply through a projection onto X axis or Y axis. The location of a valid mark indicates an area where no three consecutive empty projections exist on any X axis or Y axis, and it is easy to read marks in the found area.

Meanwhile, a binary value is used in this description, but a code may be designed more sophisticatedly if a brightness or color value is used. Various designs are possible according to performance and characteristics of a sensor. A brightness value may be used as an absolute value or as a difference between relative values, or may be used by defining several levels within one mark.

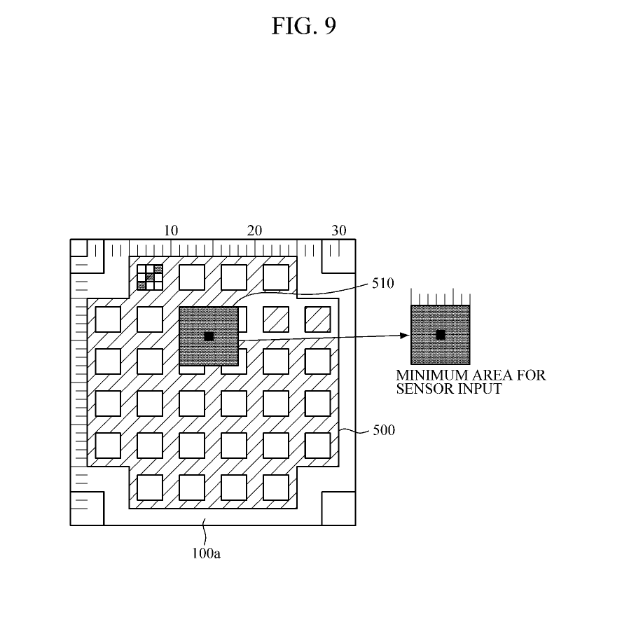

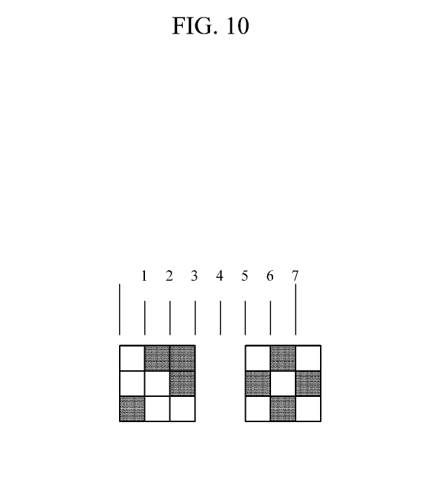

FIG. 9 is a diagram illustrating a marked surface that is designed to make marks easy to read according to an exemplary embodiment of the present disclosure, and FIG. 10 is a diagram illustrating an interval between marks.

With reference to FIGS. 6, 9 and 10, the marked surface 100a is designed to allow the sensor 122 to receive reflected light from at least one mark on the marked surface 100a. For example, if each mark is 3×3 and an interval between each two marks is two cells, as illustrated in FIG. 10, the sensor 122 needs to be designed to be larger than 7×7, which is the same size as the reference number 510. Then, the hatched area corresponding to the reference number 500 in FIG. 9 may be a range within which coordinates of the center of the sensor 122 are allowed to move, that is, a measurable moving range.

In order to read out a mark of 3×3, it is necessary to design resolution of the sensor 122 of 7×7. Of course, high resolution is required to fully cover a corresponding area, but to read a mark of 3×3, the distinguishable minimum resolution is designed by taking into consideration any error on the boundary. For example, it is appropriate for a pixel in charge of one cell to be at least 3×3 in size, and it is desirable for a pixel size of a sensor to be (7×3)×(7×3)=441 or greater. In this case, the precision may be embodied by a grid with 30 rows×3 column=90. Of course, if a smaller degree of input precision is appropriate, various modifications are possible, including reducing a mark size.

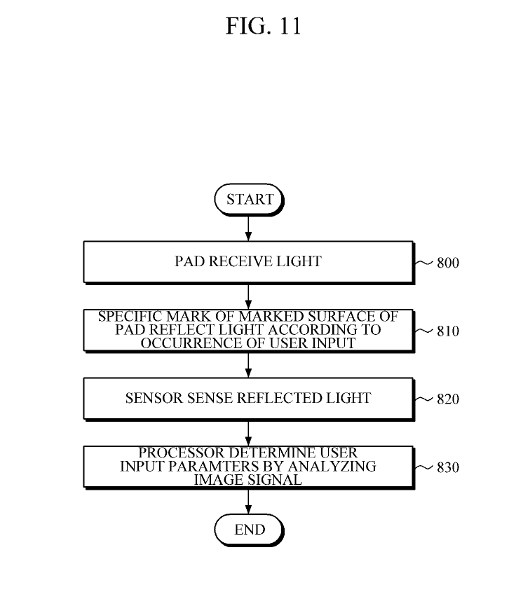

FIG. 11 is a flowchart illustrating a method for operating a user interface using the input device 1 according to an exemplary embodiment of the present disclosure.

With reference to FIGS. 6 and 11, the pad 100 of the input device 1 receives generated light from the light source 120. Then, in response to occurrence of a user's input, a marked surface of the pad 100 and an optical unit move in a relative direction to reflect light received from a light source on a specific mark in 810. Then, the sensor 122 senses the light reflected from the specific mark on the marked surface and convers the reflected light into an image signal in 820.

Then, the processor 150 determines input parameters, which include magnitude, direction, speed and distance information of the user's input in 830 by analyzing the image signal that is converted by the sensor 122. According to an exemplary embodiment, the processor 150 calculates the current relative location of the pad 100 by analyzing an image signal acquired from the sensor 122 and calculating a location of a mark, which has reflected light, on the pad 100, and then calculates a moving speed based on a difference between a previously acquired relative location and the current relative location of the pad 100 and on time required for movement from the two locations. In addition, the processor 150 determines a magnitude, a speed, and a direction vector of an input by using the calculated relative locations and moving speed.

Meanwhile, according to another exemplary embodiment of the present disclosure, it is started to receive a user's input once a marked surface is pressed, and stops receiving the user's input if the pressure on the marked surface is relieved or if the marked surface moves to a starting point after the above-described process is performed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A direction input device comprising:
a pad unit configured to comprise a marked surface formed on one side thereof and having marks of different codes or to be integrated with the marked surface;
an optical unit physically connected to the pad unit in a direction toward the marked surface and configured to irradiate light through a light source onto the marked surface of the pad unit, to sense light reflected from a specific mark on the marked surface of the pad unit by using a sensor, and to convert the reflected light into an image signal; and
a connecting unit configured to connect the pad unit and the optical unit.

2. The direction input device of claim 1,
wherein the optical unit is formed below the marked surface of the pad unit, and
wherein while the optical unit is fixed, the marked surface of the pad unit moves in a reverse direction relative to the optical unit in response to a user's force applied to the pad unit.

3. The direction input device of claim 2, wherein the pad unit comprises a button formed above the pad unit to allow a user to click, or is in the form of a clickable button for the user.

4. The direction input device of claim 1, wherein the optical unit is formed above the marked surface of the pad unit, and while the pad unit is fixed, the optical unit moves in a reverse direction relative to the marked surface of the pad unit in response to a user's force applied to the optical unit.

5. The direction input device of claim 1, wherein the marked surface of the pad unit is placed below the connecting unit in order to acquire an image from the sensor.

6. The direction input device of claim 5, wherein the connecting unit is further configured to comprise two axes so as to enable horizontal and vertical movement.

7. The direction input device of claim 1, further comprising:
a restoring unit configured to restore relative locations of the pad unit and the optical unit as starting points in a case where a user's force is not applied.

8. The direction input device of claim 1, wherein the direction input device is in the form of a mouse.

9. The direction input device of claim 1, wherein the direction input device is in the form of a ballpoint pen having a button that is able to be pressed by a user or to move horizontally and vertically.

10. The direction input device of claim 1, wherein the pad unit is coded such that there is no empty row or column with respect to cells composing a mark on the marked surface of the pad unit.

11. The direction input device of claim 1, wherein marks on the marked surface of the pad unit are coded using at least one of a binary value, a brightness value, or a color value.

12. The direction input device of claim 1, further comprising:
a processor configured to calculate a current relative location of the pad unit by analyzing an image signal acquired from a sensor of the optical unit and reading at least one mark in a pad image, which has reflected light, and a location thereof, and to calculate input parameters including a magnitude, a speed, and a direction vector of an input by using a vector value from a predetermined starting point to the current relative location.

13. The direction input device of claim 12, wherein the processor is further configured to:
calculate a moving speed based on a difference between a previously acquired relative location of the pad unit and the current relative location of the pad unit and on time required for movement from the two locations; and
calculating the magnitude, the speed, and the direction vector of the input by using the difference in the relative locations of the pad unit and the moving speed.

14. A method for operating a user interface using a direction input device, the method comprising:
receiving, by a pad of a pad unit, generated light from a light source;
in response to a user's force being applied, moving, by a marked surface of the pad unit and an optical unit, in a relative direction to reflect light received from the light source on a specific mark on the marked surface;
sensing, by a sensor of the optical unit, the light reflected from the specific mark on the marked surface and converting the reflected light into an image signal; and
calculating input parameters including a user input direction and distance information by analyzing the image signal that is converted by the sensor.

15. The method of claim 14, wherein the calculating of the input parameters comprises:
calculating a current relative location of the pad unit by analyzing the image signal and reading a location of a mark on a pad, the mark which has reflected the light; and
calculating input parameters including a magnitude, a speed, and a direction vector of an input by using a vector value from a predetermined starting point to a current relative location of the pad unit.

16. The method of claim 14, wherein the calculating of the input parameters comprises:
calculating a moving speed based on a difference between a previously acquired relative location and the current relative location of the pad unit and on time required for movement from the two locations; and
calculating the magnitude, the speed, and the direction vector of the input by using the difference in the relative locations of the pad unit and the moving speed.

17. The method of claim 14, further comprising:
starting an user input event in a case where the marked surface is pressed; and
stopping the user input event in a case where pressure on the marked surface is relieved or the marked surface moves to a starting point.
